(19) United States
(12) Patent Application Publication
(10) Pub. No.: US 2001/0018019 A1
(43) Pub. Date: Aug. 30, 2001

(54) Pre-stressed/pre-compressed gas turbine nozzle

(75) Inventors: Hoyle Jang, Schenectady, NY (US); Gary Michael Itzel, Clifton Park, NY (US); Yufeng Phillip Yu, Guilderland, NY (US)

Correspondence Address: Nixon & Vanderhye P.C., 8th Floor, 1100 N. Glebe Road, Arlington, VA, 22201-4714, US

(73) Assignee: General Electric Company

(21) Appl. No.: 09/778,033

(22) Filed: Feb. 7, 2001

Related U.S. Application Data
(63) Continuation of application No. 09/354,336, filed on Jul. 16, 1999, now abandoned.

(51) Int. Cl. F03B 1/00; F01D 9/06

(52) U.S. Cl. 415/115; 415/208.1; 415/114; 415/209.4; 415/210.1; 29/889.22

(57) ABSTRACT

A method of increasing low cycle fatigue life of a turbine nozzle comprising a plurality of stationary airfoils extending between radially inner and outer ring segments comprising a) providing at least one radial passage in each of the plurality of airfoils; b) installing a rod in the radial passage extending between the radially inner and outer ring segments and fixing one end of the rod to one of the inner and outer rings; and c) pre-loading the rod to compress the airfoil between the inner and outer ring segments.

### BACKGROUND OF THE INVENTION

The present invention relates to land-based or industrial gas turbines, for example, for electrical power generation, and particularly to the mechanical nozzle airfoil preloading device.

Low cycle fatigue (LCF) is one of the major life-limiting degradation modes in advanced industrial gas turbine nozzles. It is caused by cyclic, thermal and mechanical loads associated with gas turbine start-up, operation, and shutdown cycles. The effects of cyclic modes on LCF life generally vary within a “strain A-ratio,” or the ratio of alternating to mean strain, among other things. For a given level of cyclic load, the most damaging LCF cycle is usually one involving a hold period in compression, commonly known as LCF strain A-ratio of −1. By contrast, the least damaging LCF cycle is the one involving a hold period at zero strain, or LCF strain A-ratio of +1. The problem is that the prevailing LCF conditions for a nozzle at LCF life-limiting locations are usually a low life causing strain A-ratio of −1.

In the past, LCF life improvements for a nozzle have been sought by traditional approaches such as a design optimization to reduce LCF stresses and temperatures, and new material selections with improved LCF capabilities. With a recent gas turbine industry wide trend of increasing firing temperatures and more efficient nozzle cooling schemes, however, nozzle design stresses and temperatures often exceed the limits of even the strongest materials currently available.

### BRIEF SUMMARY OF THE INVENTION

This invention addresses the LCF life problem by pre-straining a nozzle such that the strain A-ratios at the life critical locations will be shifted from −1 to +1, resulting in a higher LCF life resulting. In the exemplary embodiment, an OEM installable mechanical device is designed to pre-strain a nozzle to counter the LCF loads, thereby extending its service life beyond the usual material limits of the conventional nozzle. More specifically, a preloading rod is inserted through each vane or airfoil of the nozzle, and fixed at one end, preferably the radial inner end. The pre-loading device, which may be in the form of a threaded nut engaging an exteriorly threaded surface of the rod, is tightened down on the rod, externally of the nozzle cover, thereby placing the airfoil in compression. After the nut has been tightened to achieve the desired pre-load, the rod may be welded to the radially outer cover of the nozzle, thereby fixing the pre-load. Preferably, the rod is located along the leading edge of the airfoil, since this is the most life-critical location in the airfoil. If considered advantageous, however, additional rods may be added in other locations within the airfoil.

Accordingly, the present invention relates to a method of increasing low cycle fatigue life of a turbine nozzle having a plurality of stationary airfoils extending between radially inner and outer ring segments comprising a) providing at least one radial passage in each of the plurality of airfoils; b) installing a rod in the radial passage extending between the inner and outer ring segments and fixing one end of the rod to one of the inner and outer rings; and c) pre-loading the rod to compress the airfoil between the inner and outer ring segments.

The invention also relates to a nozzle for a gas turbine comprising a plurality of airfoils extending between radially inner and outer ring segments; each airfoil having means for pre-loading the airfoil in compression.

### BRIEF DESCRIPTION OF THE DRAWINGS

FIG. 1 is a partial cross-sectional view of a nozzle vane illustrating a mechanical pre-loading device in accordance with the preferred embodiment of the invention; and

FIG. 2 is an enlarged cross sectional view of the leading edge cavity in FIG. 1.

### DETAILED DESCRIPTION OF THE INVENTION

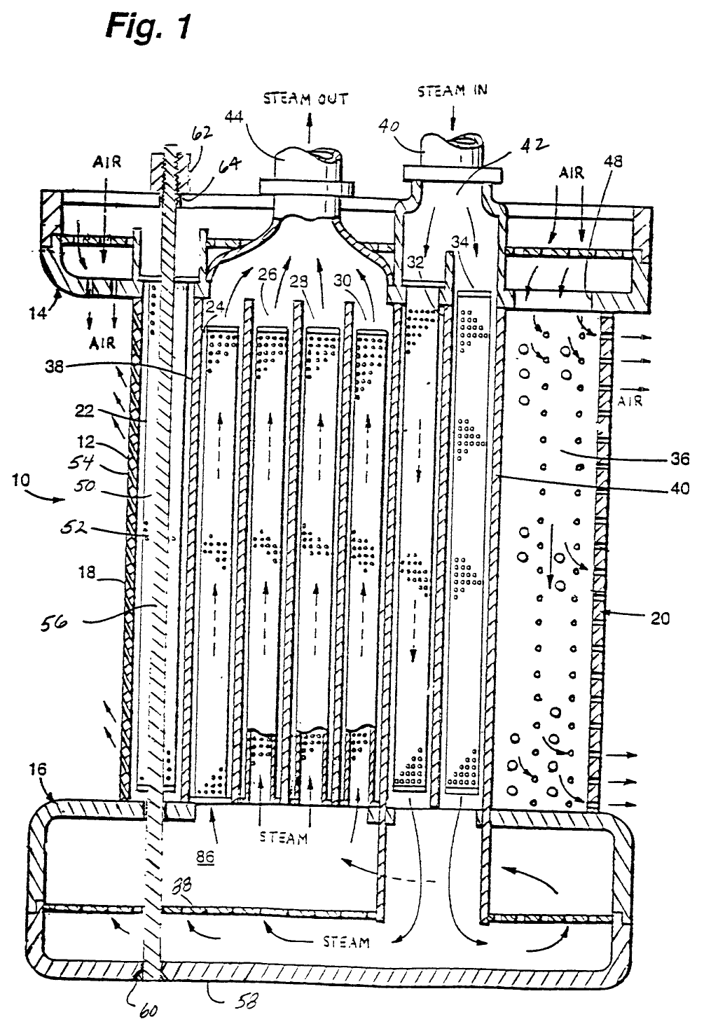

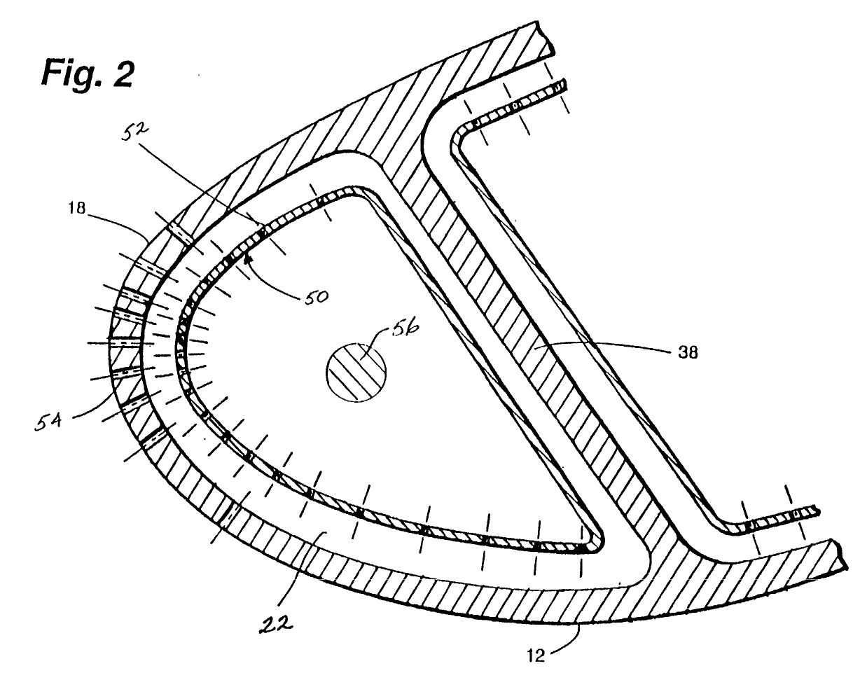

Referring to FIG. 1, there is illustrated in cross-section a nozzle segment, generally designated 10, forming one of a plurality of nozzle segments arranged in a circumferentially spaced array and forming a turbine stage. Each segment 10 includes a vane or airfoil 12 and radially spaced outer and inner walls 14 and 16, respectively. The outer and inner walls are in the form of circumferentially extending hollow ring segments defining with the vanes 12 the annular hot gas path through the nozzles of a turbine stage. In the particular arrangement of nozzle segment 10, the radially outer wall or cover 14 is supported by a shell of the turbine (not shown) which structurally supports the vanes and the radially inner wall. The nozzle segments 10 are sealed one to the other about the nozzle stage. The vane or airfoil 12 includes a plurality of cavities extending radially the length of the vane between the respective outer and inner walls 14 and 16, which cavities are spaced sequentially one behind the other from the leading edge 18 to the trailing edge 20. From the leading edge to the trailing edge, the cavities include a leading edge cavity 22, four successive intermediate cavities 24, 26, 28, 30, a pair of intermediate cavities 32 and 34 and a trailing edge cavity 36. The walls defining the cavities illustrated in cross-section extend between the pressure and suction side walls of the vane 12. This arrangement is apparent in FIG. 2 with respect to wall 38.

A pipe or tube 40 connects to a steam inlet 42 extending through the outer wall 14 for supplying cooling steam to the intermediate pair of cavities 32 and 34. A steam outlet 44 is provided through the outer wall 14 for receiving spent cooling steam from the intermediate cavities 24, 26, 28 and 30. Each of the leading edge cavity 22 and trailing edge cavity 36 has discrete air inlets 46 and 48, respectively.

An insert sleeve 50 having a plurality of transverse openings 52 is provided in the leading edge cavity 22 and spaced from the interior walls thereof as illustrated in FIGS. 1 and 2. Air flowing through inlet 46 flows into the sleeve 50 and laterally outwardly through the openings 52 for impingement-cooling of the leading edge 18. Post-impingement cooling air then flows outwardly through holes 54 spaced one from the other along the length of the leading edge 18 and also laterally one from the other, as illustrated in FIG. 2. Cavities 24, 26, 28, 30, 32 and 34 have similar insert sleeves, which need not be further described for purposes of this invention. Further details of the cooling circuit are disclosed in commonly owned copending application S. N. unknown (atty. dkt. 839-566), filed May 10, 1999. It will be appreciated, however, that this invention is applicable to other nozzle designs as well, i.e., it is not limited to the specific exemplary nozzle configuration disclosed herein.

A pre-loading rod 56 (preferably high strength steel) is inserted through the sleeve 50 in the leading edge cavity 22, extending between an upper surface of the radially outer wall or cover 14, and a lower surface of the lower or radially inner wall 16. The rod 56 is welded to the lower surface 58 of the inner wall 16, as indicated at 60. The rod extends upwardly through the wall 16 and through the sleeve 50, emerging from the radially outer wall or cover 14, with a threaded free end projecting above the upper surface of the cover. A pre-loading device, which may take the form of a threaded nut 62 (or any conventional pre-load device), may be tightened down against the cover, applying a compressive pre-load to the airfoil or vane 12. After the pre-load is applied, the rod may be fixed at its upper end by a weld indicated at 64.

Since the leading edge 18 of the airfoil 12 is the most critical life-limiting area, the rod is most effectively placed in the leading edge cavity 22, but multiple rods can be used in one or more of the remaining cavities if needed. By so pre-straining the airfoils of the nozzle, the strain A-ratios at the life critical, leading edge locations will be shifted from −1 to +1, resulting in LCF life improvements over conventional non-pre-strained nozzles. Testing has demonstrated that the low cycle fatigue life may be improved by at least a factor of 2 when the strain A-ratio is shifted from −1 to +1.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of increasing low cycle fatigue life of a turbine nozzle comprising a plurality of stationary airfoils extending between radially inner and outer ring segments comprising:
a) providing at least one radial passage in each of said plurality of airfoils;
b) installing a rod in said radial passage extending between said radially inner and outer ring segments and fixing one end of said rod to one of said inner and outer rings; and
c) pre-loading said rod to compress said airfoil between said inner and outer ring segments.

2. The method of claim 1 wherein, during step b), a lower end of said rod is fixed to said inner ring segment and a free end of said rod extends radially through said airfoil and through said outer ring segment, and a nut is threadably engaged with said rod and tightened against said outer ring segment, thereby pre-loading said airfoil in compression.

3. The method of claim 2 wherein after the nut is tightened, the rod is welded to the outer ring segment.

4. The method of claim 3 wherein steps a), b) and c) are repeated for each airfoil in the nozzle.

5. The method of claim 1 wherein a sleeve is placed within said at least one radial passage, and said rod extends through said sleeve.

6. The method of claim 1 wherein said at least one radial passage is located along a leading edge of the nozzle.

7. The method of claim 6 wherein said radial passage comprises a cooling passage.

8. A nozzle for a gas turbine comprising a plurality of airfoils extending between radially inner and outer ring segments; each airfoil having means for pre-loading said airfoil in compression.

9. The nozzle of claim 8 wherein each said airfoil has at least one radial passage extending substantially between said inner and outer ring segments, and wherein said means for pre-loading said airfoil includes a rod extending through said radial passage.

10. The nozzle of claim 9 wherein said radial passage extends along a leading edge of said airfoil.

11. The nozzle of claim 9 wherein said rod is fixed to said radially inner ring segment and wherein said pre-loading is applied at said radially outer ring segment.

12. A nozzle for a gas turbine comprising a plurality of airfoils extending between radially inner and outer ring segments; each airfoil having a pre-loading rod extending radially therethrough, said pre-loading rod having one end fixed to one 9of said radially inner and outer ring segments, and an opposite, theaded free end engaged by a threaded nut, said airfoil being under compression resulting from said threaded nut being tightened down against said radially outer ring segment.

13. The nozzle of claim 12 wherein said preloading rod extendings radially along a leading edge of said airfoil.
